(19) United States
(12) Patent Application Publication
(10) Pub. No.: US 2010/0233416 A1
(43) Pub. Date: Sep. 16, 2010

(54) MULTIPLE CASCADING RIBBED INSULATION PLATE

(76) Inventor: Patrick J. Parziale, Elyria, OH (US)

Correspondence Address: James C. Scott;Roetzel & Andress, Suite 900, 1375 East Ninth Street, Cleveland, OH, 44114, US

(21) Appl. No.: 12/723,852

(22) Filed: Mar. 15, 2010

Related U.S. Application Data
(60) Provisional application No. 61/159,923, filed on Mar. 13, 2009.

(51) Int. Cl. B32B 3/02

(52) U.S. Cl. 428/66.6

(57) ABSTRACT

Roofing insulation securement plates have multiple projecting ribs of cascading or successively differing height or projection profiles, with an innermost rib have a highest profile and successive radially outboard ribs having successively smaller heights or projection profiles for an increasing degree of flexure of the plate from the center to the outer perimeter of the plate. The plates additionally have an aperture located at the center of a centrally located recessed region of the plate through which a fastening device may be inserted for securement of the plate to an underlying roofing substrate.

### RELATED APPLICATIONS

This application claims priority to U.S. Provisional patent application No. 61/159,923, filed Mar. 13, 2009, which is incorporated herein.

### FIELD OF THE INVENTION

The present disclosure and related inventions relate to insulation plates, more specifically insulation plates used for securing insulation substrates or members in a roofing assembly or roof decking structure.

### BACKGROUND OF THE INVENTION

A type of roofing system includes a roof deck, which is considered the structural supporting surface of a building extending between the surrounding exterior walls of the building, constructed from plywood, metal decking, concrete or any other suitable material. To make the roof deck and building weather resistant an insulation substrate made of for example polyisocyanurate, expanded polystyrene or any other suitable material is installed over the roof deck.

Insulation plates are used for securing insulation substrates to underlying roof decking substructures. There are many different types of insulation plates used for this purpose. They can be of any shape and usually contain a recessed diameter hole in the center or elsewhere through which a fastener is inserted in order to secure the insulation plate to the underlying roofing deck substructure. They typically contain several ribs or reinforcement structures to adequately secure the insulation to the substrate and to hold the insulation in place against wind uplift forces.

It is well known that uplift forces have the potential to distort or destroy insulation plates potentially causing tearing or breakage of the insulation substrate. To prevent this from occurring, insulation plates have been designed to be particularly rigid around the radial outermost region of the plate to avoid bending of the plate and subsequent damage to the insulation substrate. However, enhanced rigidity along the radial outer portion of the insulation plate can actually be the cause of tearing or breakage of the insulation substrate due to concentration of forces at the perimeter. While the plate may resist bending forces applied upon it by the underlying insulation substrate under uplifting wind force conditions, the portion of the insulation substrate where the wind forces are being applied may itself tear under the enhanced strength of the outer portion of the insulation plate.

### SUMMARY OF THE INVENTION

An insulation plate having, a circular cross-sectional configuration, a plurality of concentrically disposed reinforcing ribs with successively lower projection profiles or vertical extents from the center of the plate, and a centrally located aperture through which a fastener is inserted to secure insulation substrates to an underlying roof decking substructure. The first or radially innermost rib member has the highest vertical height or profile, with each outwardly consecutive rib decreasing in height so that the plate has an increasing degree of flexibility graduated toward a perimeter region of the plate, so that forces between the insulation and the plate are reduced or not concentrated at the perimeter of the plate, in order to avoid damage to the insulation at the plate perimeter, and to evenly distribute loads over a greater surface area of the plate.

### DESCRIPTION OF THE DRAWINGS

FIG. 1A is a top view of a representative embodiment of an insulation plate of the present invention.

FIG. 1B is a cross-sectional view of the insulation plate of FIG. 1A.

FIG. 1C is a perspective view of the insulation plate of FIGS. 1A and 1B.

FIG. 2A is a profile view of an alternate embodiment of the insulation plate of the present invention.

FIG. 2B is a profile view of an alternate embodiment of the insulation plate of the present invention.

### DETAILED DESCRIPTION OF PREFERRED AND ALTERNATE EMBODIMENTS

The multiple cascading ribbed insulation plate of the present invention and related disclosure is a circular plate configured with a series of concentrically disposed reinforcement ribs radially spaced throughout the plate. Each rib is formed by an upwardly extending peak and spaces or troughs forming a valley between each rib. The first or radially innermost rib member has the highest height profile followed by at least three ribs of successively decreasing height. This configuration allows for flexure or flexing of the plate during the exertion of wind or uplift forces upon the insulation or roofing substrate and aids in preventing damage to the insulation substrate caused by the perimeter of the plate during heavy wind conditions. The plate also contains an aperture located at the center of the recessed region of the plate that is bound by the first or radially innermost rib. In a representative embodiment, the plate is made of Galvalume but can also be made of galvanized metal or any other suitable material. Although the plate is described and depicted herein as being circular and having circular concentrically disposed reinforcement ribs, the plate and corresponding ribs may be of other shape without departing from the scope of the invention.

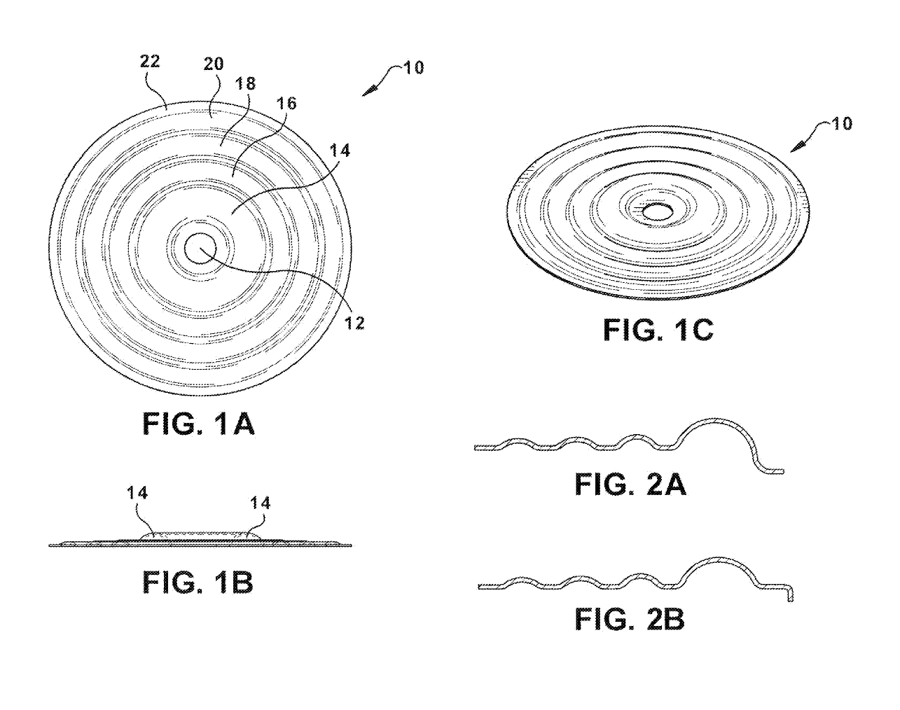

In a representative embodiment, as shown in FIG. 1A, the circular plate 10 has a diameter of approximately 2.75 inches. The diameter can range from 1.5 inches to 4.5 inches but is preferably less than 3.0 inches. The material thickness can range from 0.015 to 0.050 inches thick but is preferably between 0.017-0.020 inches. The first or radially innermost rib 14 has the highest height profile, which in the representative embodiment is 0.120 inches. The second rib 16 located radially outboard of the first rib has a respectively smaller height such as, for example, 0.57 inches. A third rib 18 located radially outboard of the second rib has a smaller height of approximately 0.47 inches and a fourth rib 20 located radially outboard of the third rib has the smallest height of approximately 0.42 inches. As shown in the cross-sectional view of the plate 10 in FIG. 1B, the plate 10 also contains an outer lip 22, outboard of the outermost rib which enables the plate to sit flush with the underlying substrate. A prospective view of the plate is shown in FIG. 1C. Other suitable decreasing rib height combinations include: 0.135 inches, 0.072 inches, 0.062 inches and 0.057 inches; 0.125 inches, 0.062 inches, 0.052 inches and 0.047 inches; and 0.115 inches, 0.052 inches, 0.042 inches and 0.037 inches. The outwardly decreasing height of the reinforcing ribs serve to enhance the rigidity of the radially inner portions of the plate which in turn effectively reinforces the centrally located recessed region along with the centrally located aperture which is configured to accommodate a fastening device. This will in effect increase the pull-through resistance with respect to the fastener disposed within the centrally located aperture.

The insulator plate 10 is secured to insulation substrate by inserting a screw, bolt, or other suitable fastener through the aperture 12 located in the center of the plate and thereby fastening it to the underlying substrate. The recessed region at the center of the plate 10 that is bound by the first or radially innermost rib 14 accommodates the head portion of the fastener such that the fastener head is entirely recessed within the recessed region thereby preventing damage to the membranes secured above the insulation plate 10 by the head of the fastener. The aperture 12 has a representative diameter of approximately 0.265 inches, although other suitable diameters may be used.

A profile view of an alternate embodiment of the multiple cascading ribbed insulator plate of the present invention and related disclosure is shown in FIGS. 2A and 2B. As in the representative embodiment the first or innermost rib has the highest vertical height or profile with each outwardly consecutive rib decreasing in height. The embodiment of FIG. 2A includes an inner recessed region that sits lower than each of the ribs and the outer lip to create a sunken recessed region and aperture. The transition between the first or radially innermost rib and the recessed region extends below the bottom surface of the plate allowing the recessed area of the plate to sit flush with the underlying substrate. The example in FIG. 2B contains an inner recessed region that sits at the same elevation as the bottom surface of the plate and the outer lip but contains a lip that extends downward around the aperture and is below the elevation of the plate. This portion does not sit flush with but sinks into the underlying substrate. These embodiments allow the plate to flex or move with potential wind forces without damaging the underlying substrate due to a concentration of forces at the perimeter of the plate.

What is claimed is:

1. An insulation plate comprising:
a plate member having a top surface and a bottom surface;
at least three reinforcing ribs radially spaced throughout the plate member;
a centrally located recessed region with aperture; and
a first or innermost rib having a first height, a second rib located outboard of the first or innermost rib and having a second height which is less than the first height and a third rib located outboard of the second rib and having a third height which is less than the second height.

2. The insulation plate of claim 1, wherein the plate member has a diameter in the range of approximately 1.5 inches to approximately 4.5 inches.

3. The insulation plate of claim 1, wherein the thickness of the plate member is in the range of approximately 0.015 inches to approximately 0.050 inches.

4. The insulation plate of claim 1, wherein the aperture has a diameter of approximately 0.0265 inches.

5. The insulation plate of claim 1 further including a fourth rib located outboard of the third rib and having a fourth height which is less than the third height.

6. The insulation plate of claim 1, wherein the first or innermost rib has a height dimension of approximately 0.120 inches, the second rib has a height dimension of approximately 0.057 inches and the third rib has a height dimension of approximately 0.047 inches.

7. The insulation plate of claim 5, wherein the first or innermost rib has a height dimension of approximately 0.120 inches, the second rib has a height dimension of approximately 0.057 inches, the third rib has a height dimension of approximately 0.047 inches and the fourth rib has a height dimension of approximately 0.042 inches.

8. The insulation plate of claim 1, wherein the first rib has a height dimension of approximately 0.115 inches, the second rib has a height dimension of approximately 0.052 inches and the third rib has a height dimension of approximately 0.042 inches.

9. The insulation plate of claim 5, wherein the first rib has a height dimension of approximately 0.115 inches, the second rib has a height dimension of approximately 0.052 inches, the third rib has a height dimension of approximately 0.042 inches and the fourth rib has a height dimension of approximately 0.037 inches.

10. The insulation plate of claim 1, wherein the first rib has a height dimension of approximately 0.125 inches, the second rib has a height dimension of approximately 0.062 inches and the third rib has a height dimension of approximately 0.052 inches.

11. The insulation plate of claim 5, wherein the first rib has a height dimension of approximately 0.125 inches, the second rib has a height dimension of approximately 0.062 inches, the third rib has a height dimension of approximately 0.052 inches and the fourth rib has a height dimension of approximately 0.047 inches.

12. The insulation plate of claim 1, wherein the first rib has a height dimension of approximately 0.135 inches, the second rib has a height dimension of approximately 0.072 inches and the third rib has a height dimension of approximately 0.062 inches.

13. The insulation plate of claim 5, wherein the first rib has a height dimension of approximately 0.135 inches, the second rib has a height dimension of approximately 0.072 inches, the third rib has a height dimension of approximately 0.062 inches and the fourth rib has a height dimension of approximately 0.057 inches.

14. The insulation plate of claim 1, wherein the centrally located recessed region extends below the bottom surface of the plate.

15. The insulation plate of claim 1, wherein the centrally located recessed region sits at the same elevation as the bottom surface of the plate.

16. The insulation plate of claim 15, wherein the aperture contains a lip that extends downward around the aperture is extends below the elevation of the bottom surface of the plate.

17. A multiple cascading ribbed insulation plate comprising:
a circular plate member;
at least three concentrically disposed reinforcing ribs radially spaced throughout the plate member;
a centrally located recessed region;
an aperture located at the center of the centrally located recessed region; and
at least two recessed regions located between the three concentrically disposed reinforcing ribs,
wherein the first or innermost rib has the highest vertical height and each outwardly consecutive rib is decreasing in height.

18. The insulation plate of claim 15, wherein the aperture has a diameter of approximately 0.0265 inches.

19. The insulation plate of claim 15, wherein the insulation plate has four concentrically disposed reinforcing ribs radially spaced throughout the plate member

20. A multiple cascading ribbed insulation plate comprising:
a circular plate member having a diameter in the range of approximately 1.5 inches to approximately 4.5 inches and a thickness of approximately 0.017 inches to approximately 0.020 inches;
a first or innermost concentrically disposed reinforcing rib having a diameter in the range of approximately 0.115 to approximately 0.135 inches;
a second concentrically disposed reinforcing rib having a diameter in the range of approximately 0.052 inches to approximately 0.072 inches;
a third concentrically disposed reinforcing rib having a diameter in the range of approximately 0.042 inches to approximately 0.062 inches;
a centrally located recessed region;
an aperture located at the center of the centrally located recessed region having a diameter of approximately 0.0265 inches; and
at least two recessed regions located between the three concentrically disposed reinforcing ribs,
wherein the centrally located recessed region extends below a bottom surface of the circular plate member.
